(19) United States
(12) Patent Application Publication
(10) Pub. No.: US 2024/0161169 A1
(43) Pub. Date: May 16, 2024

(54) USING MACHINE LEARNING TO IDENTIFY MEMORY COMPATIBILITY

(71) Applicant: Micron Technology, Inc., Boise, ID (US)

(72) Inventors: Libo WANG, Boise, ID (US); Ying ZHANG, Boise, ID (US); Soo Koon NG, Boise, ID (US)

(21) Appl. No.: 18/497,642

(22) Filed: Oct. 30, 2023

Related U.S. Application Data
(60) Provisional application No. 63/383,370, filed on Nov. 11, 2022.

(51) Int. Cl. G06Q 30/0601; G06F 40/279; G06N 20/00

(52) U.S. Cl. CPC G06Q 30/0631; G06F 40/279; G06N 20/00; G06Q 30/0627

(57) ABSTRACT

In some implementations, a device may obtain an input that identifies a device type. The device may obtain, based on the input, information indicating a configuration associated with the device type. The device may determine, using a plurality of machine learning models respectively associated with a plurality of memory types, compatibilities between the plurality of memory types and the device type based on the configuration associated with the device type. Each of the plurality of machine learning models may be trained to determine a compatibility of a respective memory type, of the plurality of memory types, with a given configuration. The device may determine a recommendation of one or more memory types for the device type based on the compatibilities between the plurality of memory types and the device type. The device may transmit an indication of the recommendation of the one or more memory types.

### CROSS-REFERENCE TO RELATED APPLICATION

This Patent application claims priority to U.S. Provisional Patent Application No. 63/383,370, filed on Nov. 11, 2022, and entitled “USING MACHINE LEARNING TO IDENTIFY MEMORY COMPATIBILITY.” The disclosure of the prior Application is considered part of and is incorporated by reference into this Patent Application.

### TECHNICAL FIELD

The present disclosure generally relates to memory compatibility and, for example, to using machine learning to identify memory compatibility.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIGS. 1A-1F are diagrams of an example associated with using machine learning to identify memory compatibility.

FIG. 2 is a diagram illustrating an example of training and using a machine learning model in connection with identifying memory compatibility.

FIG. 3 is a diagram of an example environment in which systems and/or methods described herein may be implemented.

FIG. 4 is a diagram of example components of a device associated with using machine learning to identify memory compatibility.

FIG. 5 is a flowchart of an example method associated with using machine learning to identify memory compatibility.

FIG. 6 is a flowchart of an example method associated with using machine learning to identify memory compatibility.

FIG. 7 is a flowchart of an example method associated with using machine learning to identify memory compatibility.

### DETAILED DESCRIPTION

A computing device, such as a laptop computer, a desktop computer, a gaming console, or the like, may use memory to store information used for operations of the computing device. Sometimes, memory devices installed in a computing device may be upgraded or supplemented with additional memory devices to improve the performance of the computing device. However, the additional memory devices may lack compatibility with the computing device. For example, the additional memory devices may lack compatibility with a processor of the computing device, a motherboard of the computing device, and/or software (e.g., a basic input output system (BIOS) or an operating system) of the computing device, among other examples. This may result in the additional memory devices operating with reduced efficacy in the computing device (e.g., with a less than expected capacity or speed) or failing to operate in the computing device, thereby limiting a performance of the computing device.

Moreover, numerous types of memory devices are available to accommodate the various possible hardware and software configurations that a computing device may employ. Accordingly, it may be difficult to identify in advance whether a particular memory type will be compatible with a particular device type. As a result, excessive computing resources may be expended in connection with actions involved in identifying a memory type that will be compatible with a particular device type and/or actions involved in testing various memory types in a particular device type.

Some implementations described herein enable identification of a compatible memory type with a particular device type using machine learning. In some implementations, a machine learning model may be trained to determine a compatibility between a memory type and a device type. In some implementations, the machine learning model may be trained based on review data indicating reviews associated with historical interactions relating to the memory type, based on information associated with memory speed tests, and/or based on information associated with execution of in-memory software. The trained machine learning model may be used to determine a compatibility between a memory device and a device type based on a hardware configuration and/or a software configuration associated with the device type.

In this way, a rigorous and automated process may be applied to identify memory compatibility. Use of the machine learning model may increase accuracy and consistency and reduce delay associated with identifying memory compatibility relative to requiring computing resources to be allocated for tens, hundreds, or thousands of operators to manually identify memory compatibility. Accordingly, implementations described herein enable efficient identification of compatible memory type for a device, thereby improving a performance of the device. Moreover, implementations described herein conserve computing resources that may have otherwise been expended in connection with actions involved in identifying a memory type that will be compatible with a particular device type and/or actions involved in testing various memory types in a particular device type.

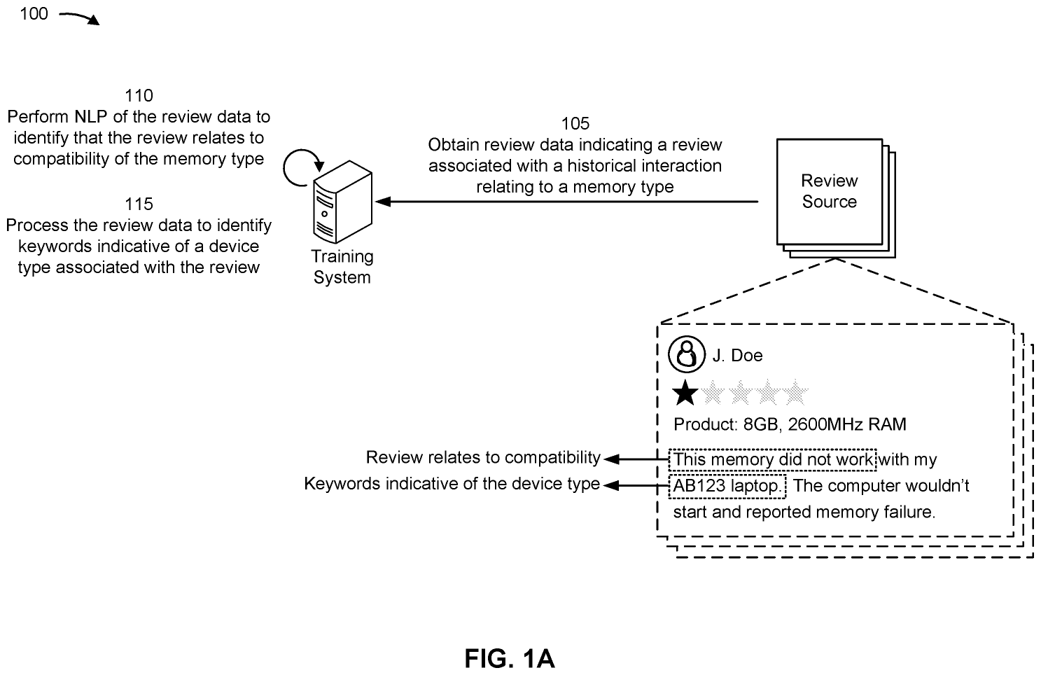

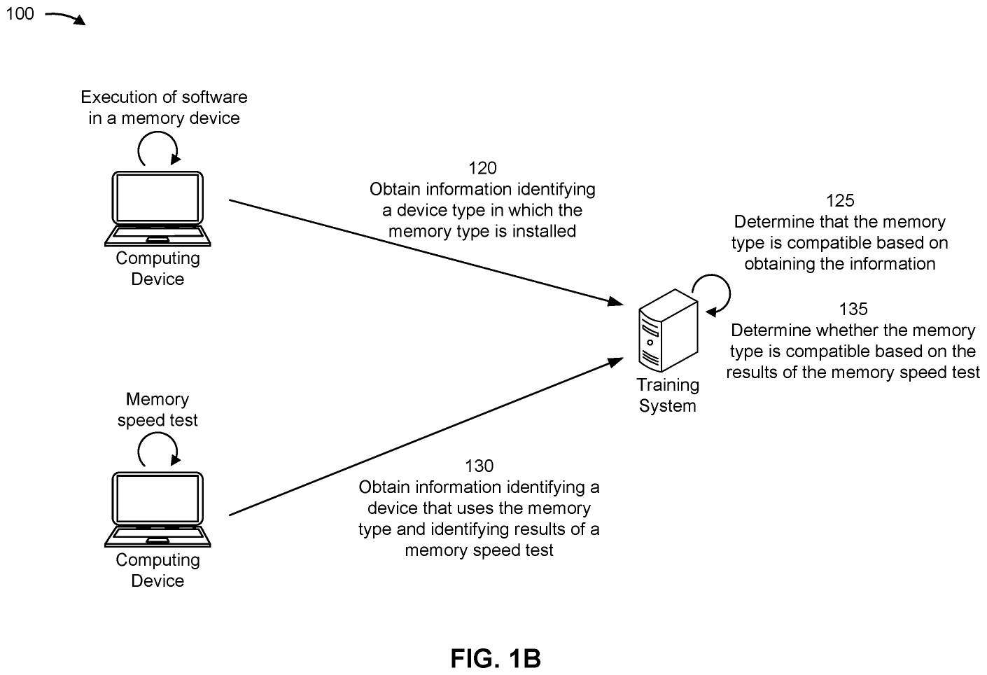

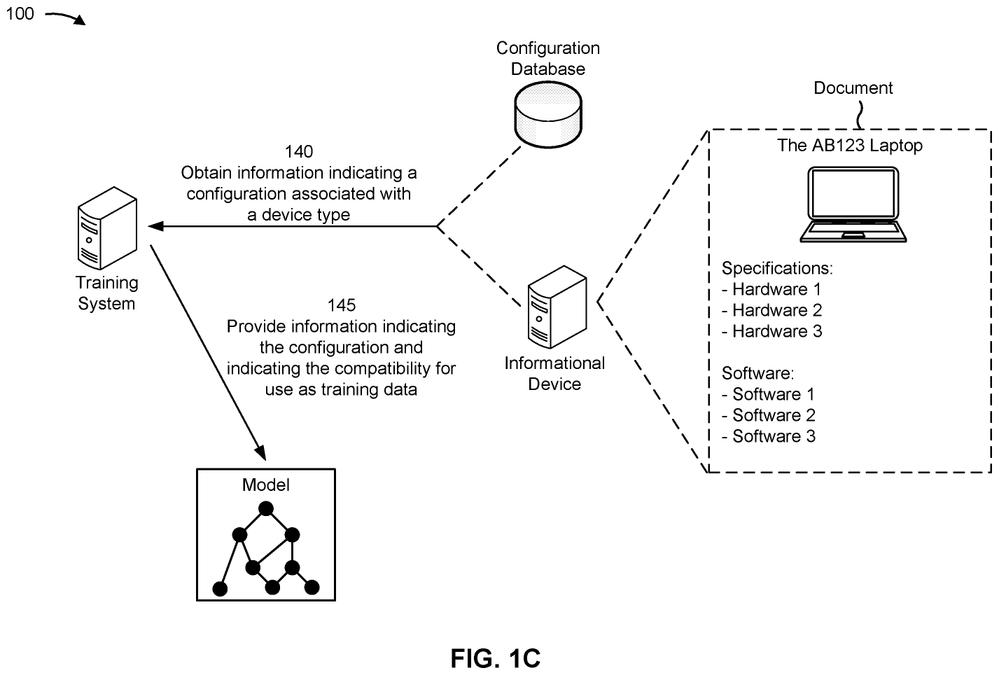

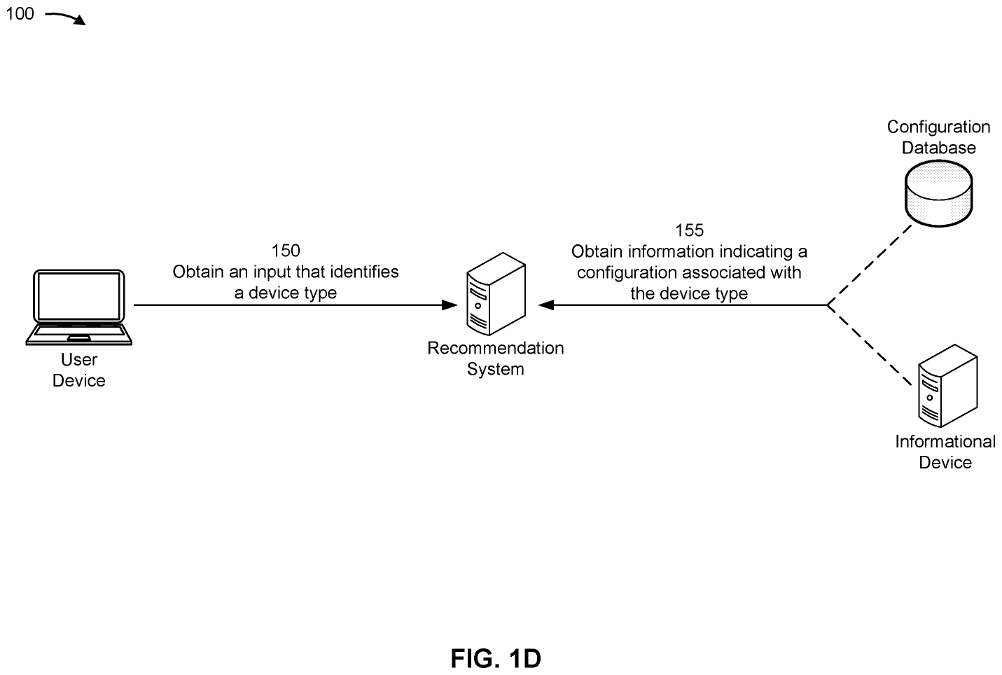

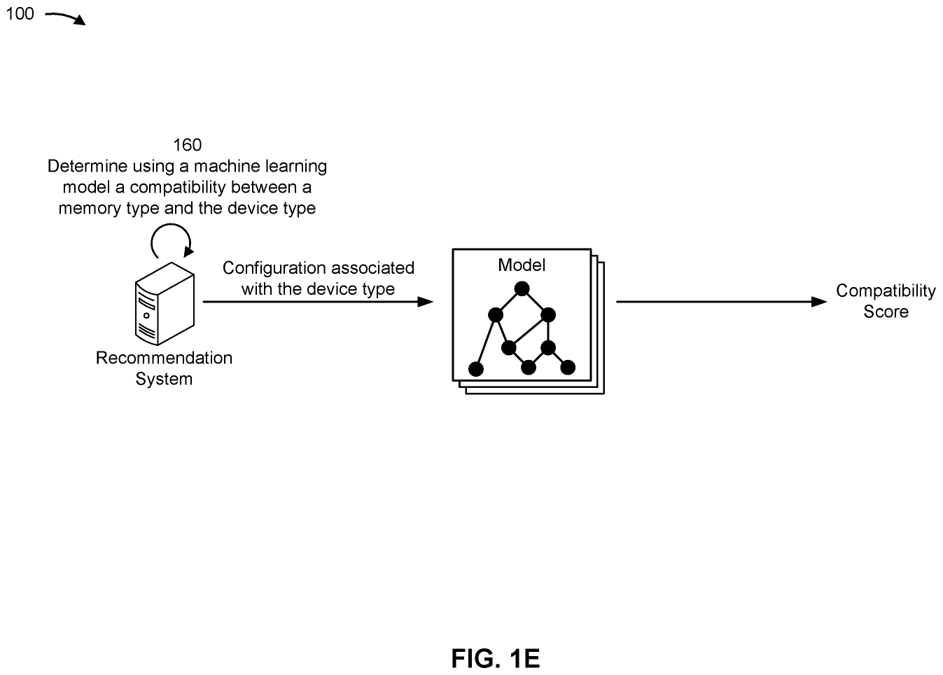

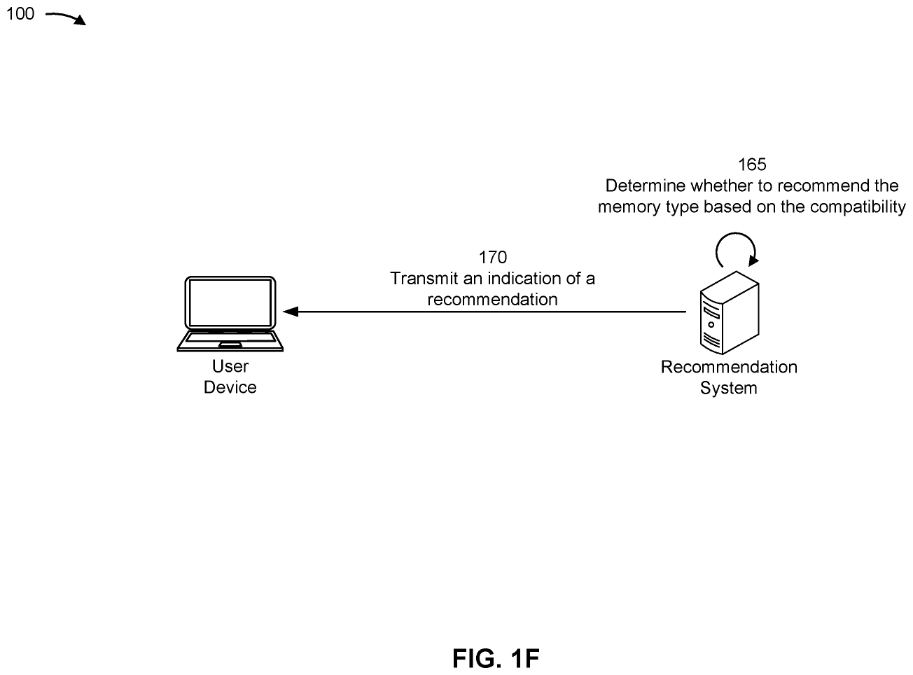

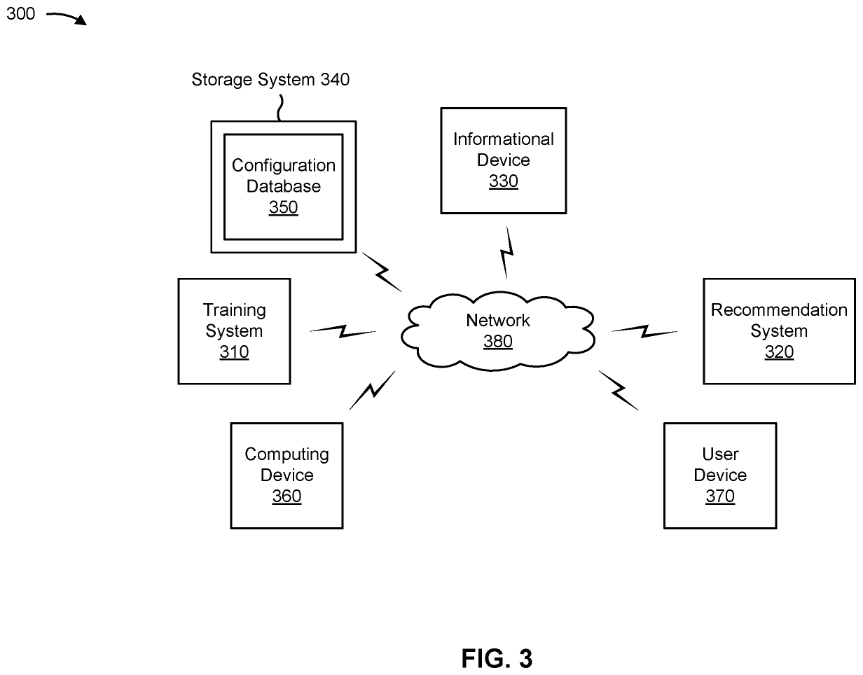

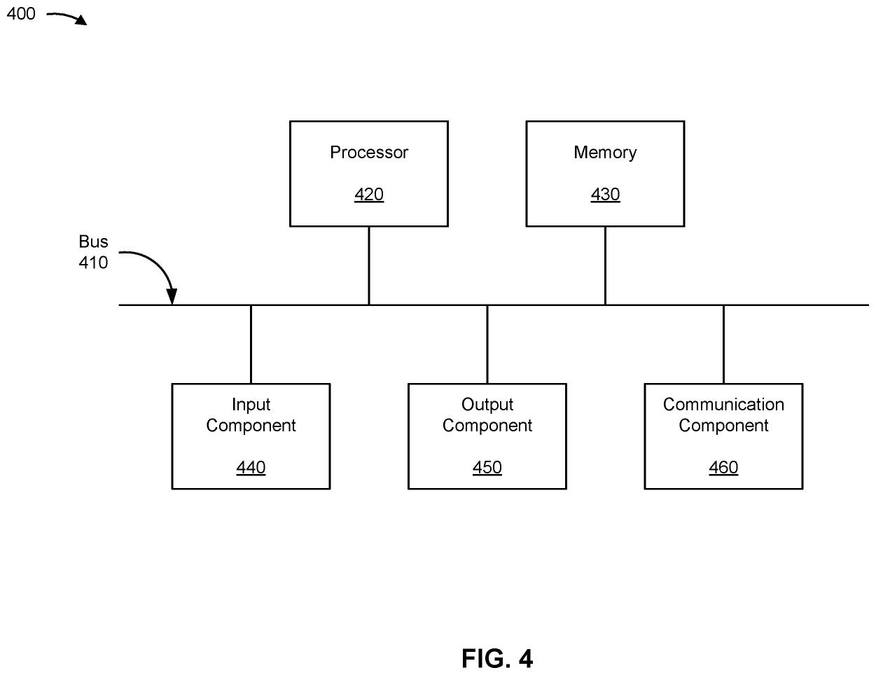

FIGS. 1A-1F are diagrams of an example 100 associated with using machine learning to identify memory compatibility. As shown in FIGS. 1A-1F, example 100 includes a training system, a recommendation system, an informational device, a configuration database, one or more computing devices, and a user device. These devices are described in more detail in connection with FIGS. 3 and 4. Although the training system and the recommendation system are shown separately in FIGS. 1A-1F, in some implementations, the training system and the recommendation system may be a single system (e.g., a single device) or sub-systems of a single system.

As shown in FIG. 1A, and by reference number 105, the training system may obtain review data indicating a review associated with a historical interaction (e.g., a purchase, a testing, a use, or the like) relating to a memory type. For example, the review may be made by a user that previously purchased, tested, or used a memory device of the memory type. The memory type may refer to a particular product model of a memory device, a particular memory technology of a memory device, and/or a particular configuration of a memory device (e.g., quantity of pins, a capacity, a speed, or the like). In some implementations, the review data may indicate a plurality of reviews associated with a plurality of historical interactions (e.g., by a plurality of users) relating to the memory type.

The training system may obtain the review data from one or more review sources (e.g., from one or more devices that implement the one or more review sources), as shown, such as from one or more websites where user reviews are posted. For example, the training system may obtain (e.g., from the devices that implement the review sources) one or more documents (e.g., web pages) that include reviews relating to the memory type. Continuing with the example, the training system may parse (e.g., scrape) the documents to extract the review data from the documents. In some implementations, the review data that is obtained by the training system may relate to reviews that satisfy one or more conditions. For example, the training system may parse the documents to extract review data relating to reviews that satisfy the one or more conditions (while discarding reviews that do not satisfy the one or more conditions). In some implementations, a condition may be that a review indicates a particular score or rating (e.g., a 1-star rating, a 5-star rating, or the like). In this way, the review data may be reduced to a manageable data set that is most likely to contain pertinent information, thereby reducing a consumption of computing resources (e.g., memory resources, processor resources, or the like) used to process the review data, as described herein.

In some implementations, the training system may obtain respective review data relating to a plurality of memory types. For example, the training system may obtain first review data relating to a first memory type (e.g., from a web page relating to the first memory type), second review data relating to a second memory type (e.g., from a web page relating to the second memory type), and so forth. Each respective review data may be processed as described below.

As shown by reference number 110, the training system may perform natural language processing (NLP) of the review data to identify that a review relates to the compatibility of the memory type (e.g., the training system may identify a plurality of reviews in the review data that relate to the compatibility of the memory type). To perform the NLP, the training system may use an NLP model configured to identify whether a review indicates a compatibility or an incompatibility with a memory type. Accordingly, the training system, to identify that the review relates to the compatibility of the memory type, may identify whether the review indicates a compatibility or an incompatibility of the memory type (e.g., using semantic analysis in connection with the NLP). In some implementations, performing the NLP of the review data may include performing semantic analysis of the review data to further identify a reason for incompatibility between the memory type and a device type, and generating a report that indicates the reason for the incompatibility (e.g., to aid in future memory device development).

As shown by reference number 115, the training system may process the review data to identify one or more keywords indicative of a device type associated with the review. For example, the training system may process the review data to identify the keywords indicative of the device type based on identifying that the review relates to the compatibility of the memory type. The device type may be a type of a computing device, and the computing device may be a laptop computer, a desktop computer, a tablet computer, a smartphone, a gaming console, or the like. The device type may refer to a particular product model of a device, a particular technology of a device, and/or to a particular configuration of a device. In this way, the training system may process the review data to identify whether the review indicates compatibility or incompatibility between the memory type and the device type. As described below, sources other than reviews may, additionally or alternatively, be used to identify compatibility or incompatibility between the memory type and a device type.

In one example, as shown in FIG. 1B, and by reference number 120, the training system may obtain information identifying a device type of a computing device in which a memory device of the memory type has been installed. The memory may include software (e.g., built-in software) that executes upon installation of the memory device. Thus, based on execution of the software in the memory device, upon installation of the memory device in the computing device, the computing device may provide, and the training system may obtain, the information identifying the device type of the computing device. For example, the software may cause the computing device to automatically provide the information (e.g., which may be stored in one or more storage locations of the computing device). As another example, the software may cause the computing device to prompt a user to input the information, and the computing device may provide the information that is input by the user. In some implementations, the information identifying the device type may further identify the memory type of the memory device (e.g., which may be automatically provided by the computing device, may be based on an input by the user, or may be inserted into the information by the software).

As shown by reference number 125, the training system may determine that the memory type is compatible with the device type of the computing device based on obtaining the information identifying the device type (which may be referred to herein as software execution data). That is, obtaining the information identifying the device type may indicate that the software in the memory device successfully executed on the device, thereby indicating that the memory type is compatible with the device type. For example, if the information identifying the device type is not obtained, then this may indicate that the software in the memory device did not successfully execute on the device, thereby indicating that the memory type is incompatible with the device. In some implementations, the information described in connection with reference number 120 may further include an indication of whether the memory type is compatible with the device type. For example, the software may cause the computing device to prompt a user to input an indication of whether the memory type is compatible with the device type, and the computing device may provide the indication that is input by the user with the information.

In another example, as shown by reference number 130, the training system may obtain information identifying a device type of a computing device that uses a memory device of the memory type and identifying results of a memory speed test for the memory device performed on the computing device. The memory speed test may be performed by software that executes on the computing device. Based on performing the memory speed test, the computing device may provide, and the training system may obtain, the information identifying the device type of the computing device. For example, the software may cause the computing device to automatically provide the information, in a similar manner as described above. As another example, the software may cause the computing device to prompt a user to input the information, and the computing device may provide the information that is input by the user, in a similar manner as described above. In some implementations, the information may further identify the memory type of the memory device (e.g., which may be automatically provided by the computing device, may be based on an input by the user, or may be inserted into the information by the software). The results of the memory speed test may indicate a speed (e.g., a data rate) at which the memory device operates in the computing device. The speed may be an average speed, a peak speed, a minimum speed, or the like.

As shown by reference number 135, the training system may determine whether the memory type is compatible with the device type based on the results of the memory speed test (which may be referred to herein as memory speed test data). For example, if the results indicate a speed of the memory device that is below (e.g., by a threshold amount) a specified speed (e.g., an advertised speed, a bench-tested speed, or the like) for the memory type, then the training system may determine that the memory type is incompatible with the device type. In some implementations, the information described in connection with reference number 130 may further include an indication of whether the memory type is compatible with the device type. For example, the software may cause the computing device to prompt a user to input an indication of whether the memory type is compatible with the device type, and the computing device may provide the indication that is input by the user with the information.

As shown in FIG. 1C, and by reference number 140, the training system may obtain information indicating a configuration associated with a device type. For example, the training system may obtain information indicating a configuration associated with a device type identified in a review of the review data as described in connection with reference number 115, a configuration associated with a device type identified by information obtained by the training system as described in connection with reference number 120, and/or a configuration associated with a device type identified by information obtained by the training system as described in connection with reference number 130.

A configuration associated with a device type may indicate a hardware configuration associated with the device type and/or a software configuration associated with the device type. The hardware configuration may identify a configuration of hardware that comes standard with the device type. The hardware configuration may identify one or more processors of the device type (e.g., by product model numbers and/or specifications of the processors), a motherboard of the device type (e.g., by a product model number and/or specifications of the motherboard), one or more expansion cards of the device type (e.g., by product model numbers and/or specifications of the expansion cards), and/or one or more memory devices (e.g., pre-existing memory devices) of the device type (e.g., by product model numbers and/or specifications of the memory devices). The software configuration may identify a configuration of software that comes standard with the device type. The software configuration may identify a BIOS of the device type, an operating system of the device type, firmware of the device type, or application software of the device type.

In some implementations, to obtain the information indicating the configuration, the training system may retrieve the information indicating the configuration from a data structure, such as the configuration database shown. The data structure may include data that maps device types to configurations (e.g., hardware and/or software configurations). In some implementations, to obtain the information indicating the configuration, the training system may parse a document relating to the device type to identify the configuration. Parsing the document may include extracting (e.g., scraping) data from the document and/or performing NLP of the extracted data to identify the configuration in the extracted data. The document may be a web page, such as a product page relating to the device type, a brochure, a specification sheet, or the like. As shown, the training system may obtain the document from the informational device (e.g., a web server).

As shown by reference number 145, the training system may provide, for use as training data for a machine learning model associated with the memory type, information indicating a configuration associated with a device type and indicating whether the memory type and the device type are compatible (e.g., indicating that the memory type and the device type are compatible or indicating that the memory type and the device type are incompatible). Whether the memory type and the device type are compatible may be based on a review, as described in connection with reference number 110, based on obtaining information identifying the device type responsive to execution of software in a memory device, as described in connection with reference number 125, and/or based on results of a memory speed test, as described in connection with reference number 135. The training data may be for training the machine learning model to determine compatibility between a given device type and the memory type. That is, the machine learning model may be particular to the memory type. Thus, a plurality of machine learning models, each particular to a respective memory type, may be trained in a similar manner.

In some implementations, where the compatibility of the memory type and the device type are based on a review, the training system may provide the information for use as training data based on determining that the review is in agreement, as to compatibility (e.g., between the memory type and the device type), with a majority of a plurality of reviews associated with a plurality of historical interactions relating to the memory type. For example, if the majority of the reviews indicate that the memory type and the device type are compatible, then the training system may use, as training data, a review that also indicates that the memory type and the device type are compatible. In some implementations, where the compatibility of the memory type and the device type are based on a review, the training system may discard the review (e.g., refrain from using the review for training data) based on determining that the review is in conflict, as to compatibility, with the majority of the plurality of reviews. For example, if the majority of the reviews indicate that the memory type and the device type are compatible, then the training system may refrain from using, as training data, a review that indicates that the memory type and the device type are incompatible. In this way, noisy data may be removed from the training data, thereby improving the accuracy of the machine learning model.

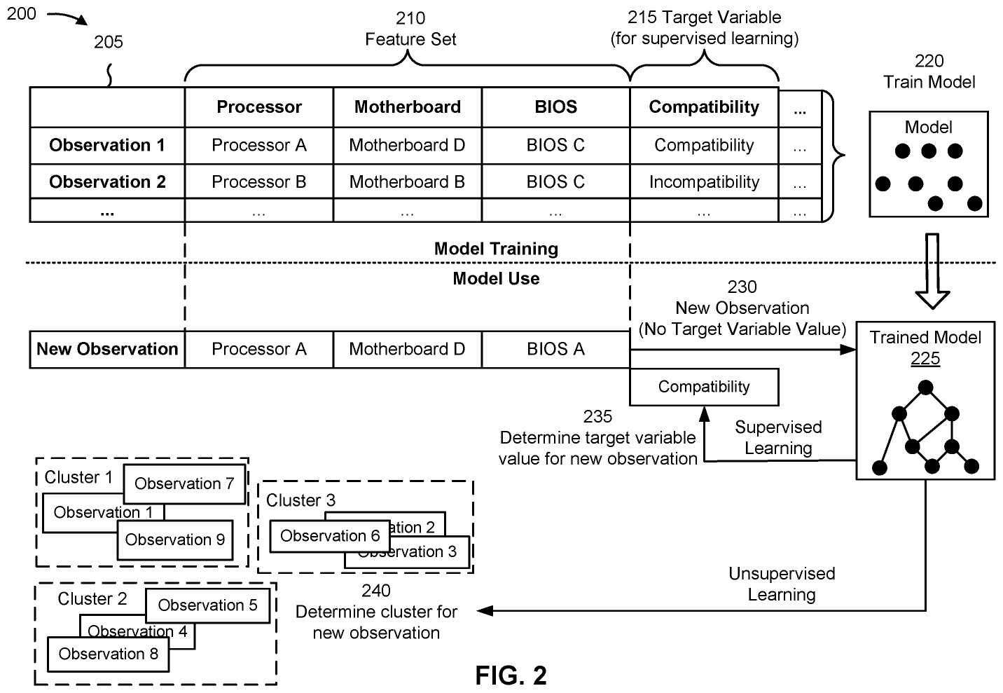

As described in connection with FIG. 2, the machine learning model (e.g., the plurality of machine learning models, each particular to a respective memory type) may be trained and/or re-trained (e.g., by the training system or another machine learning system) based on data provided by the training system. The trained machine learning model (e.g., the plurality of trained machine learning models) may be used by the recommendation system to determine compatibility between a memory type and a device type, as described below.

As shown in FIG. 1D, and by reference number 150, the recommendation system may obtain, from a user device, an input that identifies a device type. For example, the user device may provide the input that identifies the device type in order to receive a recommendation of one or more memory types that are compatible with the device type. In some implementations, the input may indicate a model identifier (e.g., a product model identifier) that identifies the device type. The device type may be a type of the user device or another device. In some implementations, the user device may provide the input via a user interface associated with the recommendation system.

As shown by reference number 155, the recommendation system may obtain information indicating a configuration associated with the device type, in a similar manner as described in connection with reference number 140. The configuration may indicate a hardware configuration associated with the device type and/or a software configuration associated with the device type, as described above.

As shown in FIG. 1E, and by reference number 160, the recommendation system may determine, using a machine learning model (trained as described above) that is associated with a memory type, a compatibility between the memory type and the device type based on the configuration associated with the device type. For example, the recommendation system may provide, as input to the machine learning model, information indicating the configuration associated with the device type, and obtain, as an output of the machine learning model, information indicating the compatibility between the memory type and the device type. In some implementations, the output of the machine learning model may be a compatibility score (e.g., indicating a probability of compatibility). That is, the compatibility between the memory type and the device type determined by the recommendation system may be expressed as a compatibility score.

The machine learning model may be trained to determine a compatibility of the memory type with a given configuration based on review data indicating reviews associated with historical interactions relating to the memory type, as described herein. Additionally, or alternatively, the machine learning model may be trained to determine the compatibility based on memory speed test data, as described herein. Additionally, or alternatively, the machine learning model may be trained to determine the compatibility based on software execution data, as described herein. Additionally, or alternatively, the machine learning model may be trained to determine the compatibility based on user inputs indicating compatibility in connection with a memory speed test and/or a software execution, as described herein.

In some implementations, the recommendation system may determine, using a plurality of machine learning models (trained as described above) that are respectively associated with a plurality of memory types, compatibilities between the plurality of memory types and the device type based on the configuration associated with the device type. For example, each of the machine learning models may be trained to determine a compatibility of a respective memory type, of the plurality of memory types, with a given configuration. Each of the machine learning models may be trained based on review data, memory speed test data, software execution data, and/or user inputs, as described above. As described above, the compatibilities between the plurality of memory types and the device type may be expressed as compatibility scores.

As shown in FIG. 1F, and by reference number 165, the recommendation system may determine whether to recommend the memory type as being compatible with the device type based on the compatibility, between the memory type and the device type, that is determined using the machine learning model. For example, the recommendation system may determine to recommend the memory type as being compatible with the device type if the compatibility score, output by the machine learning model in connection with the device type, satisfies a threshold.

In some implementations, the recommendation system may determine a recommendation of one or more memory types based on compatibilities, between the plurality of memory types and the device type, determined using the plurality of machine learning models. For example, the recommendation system may determine the one or more memory types for the recommendation based on respective compatibility scores output by the plurality of machine learning models. As an example, a memory type associated with a compatibility score that satisfies a threshold may be included in the recommendation. As another example, one or more memory types associated with the highest compatibility scores may be included in the recommendation.

As shown by reference number 170, the recommendation system may transmit, to the user device, an indication of the recommendation determined by the recommendation system. For example, the indication may indicate one or more memory types determined to be compatible with the device type. In some implementations, the indication may be presented in the user interface associated with the recommendation system. In some implementations, the indication may include one or more input elements configured to cause, in response to a user input, the user device to display information relating to the one or more memory types of the recommendation. Additionally, or alternatively, the indication may include one or more input elements configured to cause, in response to a user input, the user device to add one or more products associated with the one or more memory types to a virtual shopping cart. Additionally, or alternatively, the indication may include one or more input elements configured to cause, in response to a user input, the user device to execute a transaction for one or more products associated with the one or more memory types.

In this way, a compatible memory type may be efficiently identified for a device. Accordingly, a performance of the device, using the compatible memory, may be improved. Moreover, excessive computing resources that may have otherwise been expended in connection with actions involved in identifying a memory type that will be compatible with a particular device type and/or actions involved in testing various memory types in a particular device type may be conserved.

As indicated above, FIGS. 1A-1F are provided as an example. Other examples may differ from what is described with regard to FIGS. 1A-1F.

FIG. 2 is a diagram illustrating an example 200 of training and using a machine learning model in connection with identifying memory compatibility. The machine learning model training and usage described herein may be performed using a machine learning system. The machine learning system may include or may be included in a computing device, a server, a cloud computing environment, or the like, such as the training system or the recommendation system described in more detail elsewhere herein. The memory learning model may be associated with a particular memory type, as described herein. In some implementations, multiple machine learning models, each associated with a respective memory type, may be trained and used as described in FIG. 2.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the training system, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the training system. For example, the machine learning system may identify a feature set (e.g., one or more features and/or feature values) by extracting the feature set from structured data, by performing NLP to extract the feature set from unstructured data, and/or by receiving input from an operator.

As an example, a feature set for a set of observations may include a first feature of a processor, a second feature of a motherboard, a third feature of a BIOS, and so on. As shown, for a first observation, the first feature may have a value of processor A (referring to a particular processor type), the second feature may have a value of motherboard D (referring to a particular motherboard type), the third feature may have a value of BIOS C (referring to a particular BIOS type), and so on. These features and feature values are provided as examples, and may differ in other examples. For example, the feature set may include one or more of the following features: processor(s), motherboard, expansion card(s), memory device(s), operating system, BIOS, firmware, and/or application software, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is compatibility (with the memory type associated with the machine learning model), which has a value of compatibility for the first observation. In some implementations, the target variable may be a compatibility score indicating a probability or a confidence level that the memory type, associated with the machine learning model, is compatible with a device type.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature value of processor A, a second feature value of motherboard B, a third feature of BIOS C, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of compatible for the target variable of compatibility for the new observation, as shown by reference number 235. Based on this prediction, the machine learning system may provide a recommendation, may provide output for determination of a recommendation, may perform an automated action, and/or may cause an automated action to be performed (e.g., by instructing another device to perform the automated action), among other examples.

In some implementations, the trained machine learning model 225 may classify (e.g., cluster) the new observation in a cluster, as shown by reference number 240. The observations within a cluster may have a threshold degree of similarity. As an example, the machine learning system may classify the new observation in a first cluster (e.g., compatible), a second cluster (e.g., incompatible), a third cluster (e.g., unknown), or the like. The machine learning system may provide a recommendation, perform an automated action, and/or may cause an automated action to be performed (e.g., by instructing another device to perform the automated action) based on classifying the new observation in a particular cluster.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model).

In this way, the machine learning system may apply a rigorous and automated process to identify memory compatibility. The machine learning system may enable recognition and/or identification of tens, hundreds, thousands, or millions of features and/or feature values for tens, hundreds, thousands, or millions of observations, thereby increasing accuracy and consistency and reducing delay associated with identifying memory compatibility relative to requiring computing resources to be allocated for tens, hundreds, or thousands of operators to manually identify memory compatibility using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a training system 310, a recommendation system 320, an informational device 330, a storage system 340 that includes a configuration database 350, a computing device 360, a user device 370, and a network 380. Devices of environment 300 may interconnect via wired connections, wireless connections, or a combination of wired and wireless connections.

The training system 310 may include one or more devices capable of receiving, generating, storing, processing, providing, and/or routing information associated with using machine learning to identify memory compatibility, as described elsewhere herein. The training system 310 may include a communication device and/or a computing device. For example, the training system 310 may include a server, such as an application server, a client server, a web server, a database server, a host server, a proxy server, a virtual server (e.g., executing on computing hardware), or a server in a cloud computing system. In some implementations, the training system 310 may include computing hardware used in a cloud computing environment.

The recommendation system 320 may include one or more devices capable of receiving, generating, storing, processing, providing, and/or routing information associated with using machine learning to identify memory compatibility, as described elsewhere herein. The recommendation system 320 may include a communication device and/or a computing device. For example, the recommendation system 320 may include a server, such as an application server, a client server, a web server, a database server, a host server, a proxy server, a virtual server (e.g., executing on computing hardware), or a server in a cloud computing system. In some implementations, the recommendation system 320 may include computing hardware used in a cloud computing environment. In some implementations, the training system 310 and the recommendation system 320 may be included in the same device.

The informational device 330 may include one or more devices capable of receiving, generating, storing, processing, providing, and/or routing information associated with a configuration of a device type, as described elsewhere herein. The informational device 330 may include a communication device and/or a computing device. For example, the informational device 330 may include a server, such as an application server, a client server, a web server, a database server, a host server, a proxy server, a virtual server (e.g., executing on computing hardware), or a server in a cloud computing system. In some implementations, the informational device 330 may include computing hardware used in a cloud computing environment.

The storage system 340 may include one or more devices capable of receiving, generating, storing, processing, and/or providing information associated with a configuration of a device type, as described elsewhere herein. The storage system 340 may include a communication device and/or a computing device. For example, the storage system 340 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the storage system 340 may store the configuration database 350, as described elsewhere herein.

The computing device 360 may include one or more devices capable of receiving, generating, storing, processing, and/or providing information associated with a device type of the computing device 360 and/or results of a memory speed test performed on the computing device 360, as described elsewhere herein. The computing device 360 may include a communication device and/or a computing device. For example, the computing device 360 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The user device 370 may include one or more devices capable of receiving, generating, storing, processing, and/or providing information associated with memory compatibility for a device type, as described elsewhere herein. The user device 370 may include a communication device and/or a computing device. For example, the user device 370 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network 380 may include one or more wired and/or wireless networks. For example, the network 380 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 380 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with using machine learning to identify memory compatibility. The device 400 may correspond to training system 310, recommendation system 320, informational device 330, storage system 340, computing device 360, and/or user device 370. In some implementations, training system 310, recommendation system 320, informational device 330, storage system 340, computing device 360, and/or user device 370 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4.

Additionally, or alternatively, a set of components (e.g., one or more components) of the device 400 may perform one or more functions described as being performed by another set of components of the device 400.

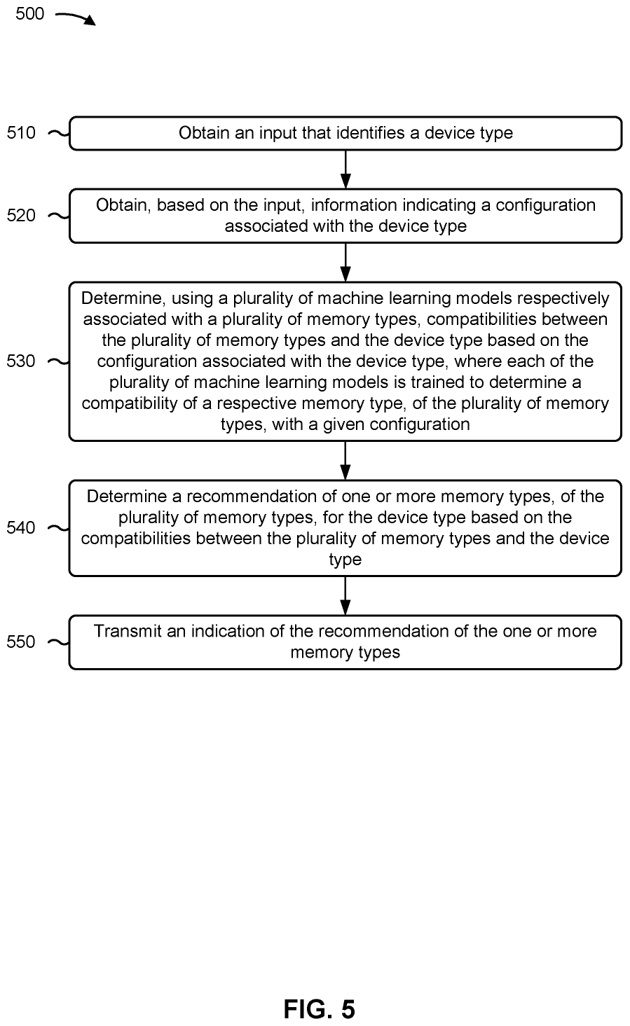

FIG. 5 is a flowchart of an example method 500 associated with using machine learning to identify memory compatibility. In some implementations, a device (e.g., the recommendation system 320) may perform or may be configured to perform the method 500. In some implementations, another device or a group of devices separate from or including the device (e.g., the training system 310, the informational device 330, the storage system 340, the computing device 360, and/or the user device 370) may perform or may be configured to perform the method 500. Additionally, or alternatively, one or more components of the device (e.g., processor 420, memory 430, input component 440, output component 450, and/or communication component 460) may perform or may be configured to perform the method 500. Thus, means for performing the method 500 may include the device and/or one or more components of the device. Additionally, or alternatively, a non-transitory computer-readable medium may store one or more instructions that, when executed by the device, cause the device to perform the method 500.

As shown in FIG. 5, the method 500 may include obtaining an input that identifies a device type (block 510). As further shown in FIG. 5, the method 500 may include obtaining, based on the input, information indicating a configuration associated with the device type (block 520). As further shown in FIG. 5, the method 500 may include determining, using a plurality of machine learning models respectively associated with a plurality of memory types, compatibilities between the plurality of memory types and the device type based on the configuration associated with the device type, where each of the plurality of machine learning models is trained to determine a compatibility of a respective memory type, of the plurality of memory types, with a given configuration (block 530). As further shown in FIG. 5, the method 500 may include determining a recommendation of one or more memory types, of the plurality of memory types, for the device type based on the compatibilities between the plurality of memory types and the device type (block 540). As further shown in FIG. 5, the method 500 may include transmitting an indication of the recommendation of the one or more memory types (block 550).

The method 500 may include additional aspects, such as any single aspect or any combination of aspects described below and/or described in connection with one or more other methods or operations described elsewhere herein.

In a first aspect, the compatibilities between the plurality of memory types and the device type are expressed as compatibility scores.

In a second aspect, alone or in combination with the first aspect, obtaining the information indicating the configuration associated with the device type includes parsing a document relating to the device type to identify the configuration associated with the device type.

In a third aspect, alone or in combination with one or more of the first and second aspects, obtaining the information indicating the configuration associated with the device type includes retrieving the information indicating the configuration associated with the device type from a data structure.

In a fourth aspect, alone or in combination with one or more of the first through third aspects, the configuration is at least one of a hardware configuration associated with the device type or a software configuration associated with the device type.

In a fifth aspect, alone or in combination with one or more of the first through fourth aspects, the hardware configuration identifies at least one of one or more processors of the device type, a motherboard of the device type, one or more expansion cards of the device type, or one or more memory devices of the device type.

In a sixth aspect, alone or in combination with one or more of the first through fifth aspects, the software configuration identifies at least one of a BIOS of the device type, an operating system of the device type, firmware of the device type, or application software of the device type.

In a seventh aspect, alone or in combination with one or more of the first through sixth aspects, the plurality of machine learning models are trained based on review data indicating reviews associated with historical interactions relating to the plurality of memory types.

In an eighth aspect, alone or in combination with one or more of the first through seventh aspects, the input indicates a model identifier that identifies the device type.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

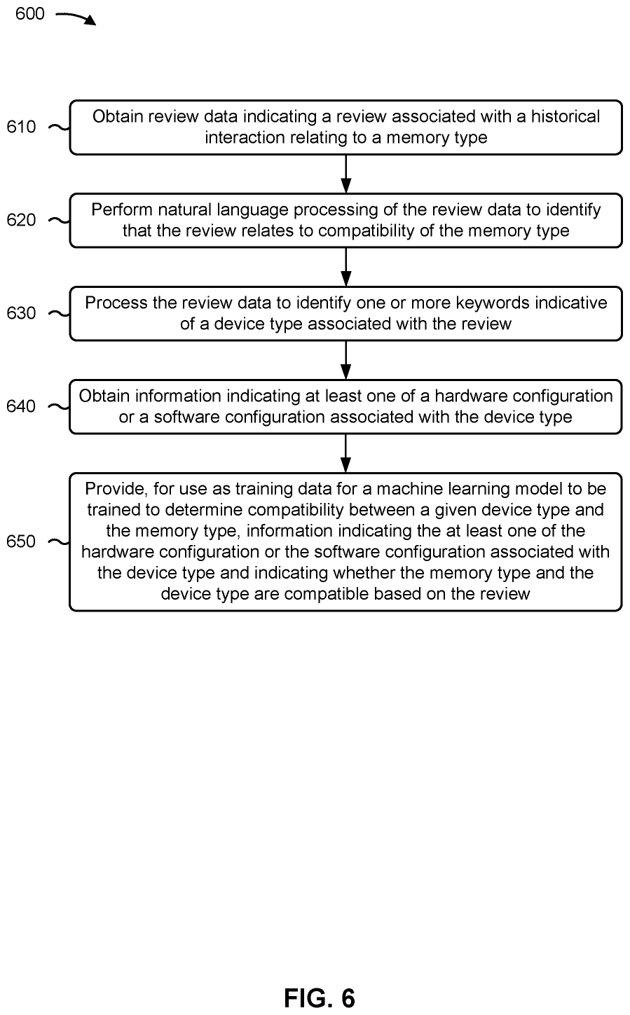

FIG. 6 is a flowchart of an example method 600 associated with using machine learning to identify memory compatibility. In some implementations, a device (e.g., the training system 310) may perform or may be configured to perform the method 600. In some implementations, another device or a group of devices separate from or including the device (e.g., the recommendation system 320, the informational device 330, the storage system 340, the computing device 360, and/or the user device 370) may perform or may be configured to perform the method 600. Additionally, or alternatively, one or more components of the device (e.g., processor 420, memory 430, input component 440, output component 450, and/or communication component 460) may perform or may be configured to perform the method 600. Thus, means for performing the method 600 may include the device and/or one or more components of the device. Additionally, or alternatively, a non-transitory computer-readable medium may store one or more instructions that, when executed by the device, cause the device to perform the method 600.

As shown in FIG. 6, the method 600 may include obtaining review data indicating a review associated with a historical interaction relating to a memory type (block 610). As further shown in FIG. 6, the method 600 may include performing natural language processing of the review data to identify that the review relates to compatibility of the memory type (block 620). As further shown in FIG. 6, the method 600 may include processing the review data to identify one or more keywords indicative of a device type associated with the review (block 630). As further shown in FIG. 6, the method 600 may include obtaining information indicating at least one of a hardware configuration or a software configuration associated with the device type (block 640). As further shown in FIG. 6, the method 600 may include providing, for use as training data for a machine learning model to be trained to determine compatibility between a given device type and the memory type, information indicating the at least one of the hardware configuration or the software configuration associated with the device type and indicating whether the memory type and the device type are compatible based on the review (block 650).

The method 600 may include additional aspects, such as any single aspect or any combination of aspects described below and/or described in connection with one or more other methods or operations described elsewhere herein.

In a first aspect, the review data indicates a plurality of reviews associated with a plurality of historical interactions relating to the memory type, and the method 600 may include determining that the review is in agreement, as to compatibility, with a majority of the plurality of reviews, where the information is provided for use as the training data for the machine learning model based on determining that the review is in agreement with the majority of the plurality of reviews.

In a second aspect, alone or in combination with the first aspect, the review data indicates a plurality of reviews associated with a plurality of historical interactions relating to the memory type, and the method 600 may include determining that an additional review, of the plurality of reviews, is in conflict, as to compatibility, with a majority of the plurality of reviews, and discarding the additional review based on determining that the review is in conflict with the majority of the plurality of reviews.

In a third aspect, alone or in combination with one or more of the first and second aspects, the method 600 includes obtaining information identifying an additional device type of a device that uses a memory device of the memory type and identifying results of a memory speed test for the memory device performed on the device, determining, based on the results of the memory speed test, whether the memory type is compatible with the additional device type, obtaining information indicating a configuration associated with the additional device type, and providing, for use as training data for the machine learning model, information indicating the configuration associated with the additional device type and indicating whether the memory type and the additional device type are compatible based on the results of the memory speed test.

In a fourth aspect, alone or in combination with one or more of the first through third aspects, the method 600 includes obtaining, based on execution of software in a memory device, of the memory type, upon installation of the memory device in a device, information identifying an additional device type of the device, determining that the memory type is compatible with the additional device type based on obtaining the information identifying the additional device type, obtaining information indicating a configuration associated with the additional device type, and providing, for use as training data for the machine learning model, information indicating the configuration associated with the additional device type and indicating that the memory type and the additional device type are compatible.

In a fifth aspect, alone or in combination with one or more of the first through fourth aspects, the method 600 includes performing semantic analysis of the review data to further identify a reason for incompatibility between the memory type and the device type, and generating a report that indicates the reason for incompatibility between the memory type and the device type.

In a sixth aspect, alone or in combination with one or more of the first through fifth aspects, the hardware configuration identifies at least one of one or more processors of the device type, a motherboard of the device type, one or more expansion cards of the device type, or one or more memory devices of the device type.

In a seventh aspect, alone or in combination with one or more of the first through sixth aspects, the software configuration identifies at least one of a BIOS of the device type, an operating system of the device type, firmware of the device type, or application software of the device type.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

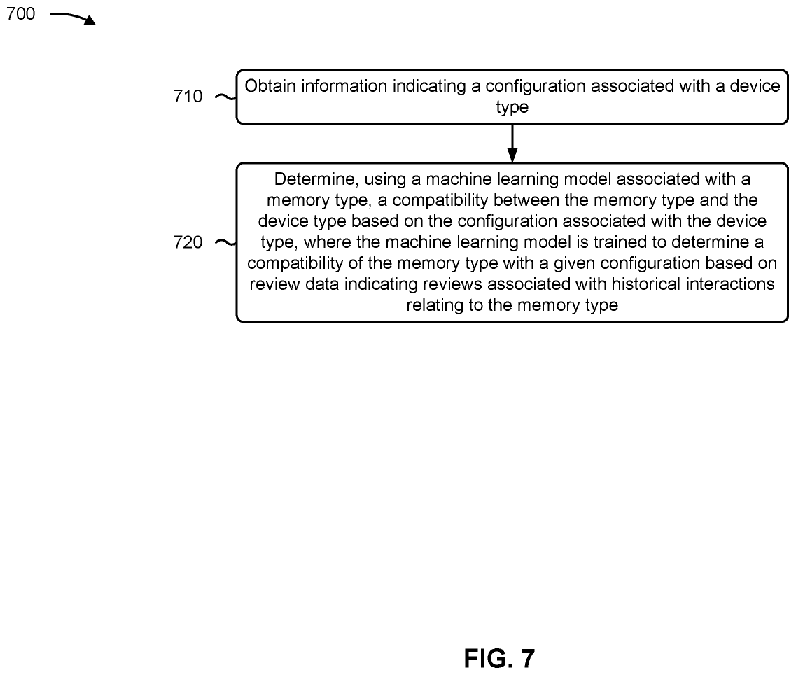

FIG. 7 is a flowchart of an example method 700 associated with using machine learning to identify memory compatibility. In some implementations, a device (e.g., the recommendation system 320) may perform or may be configured to perform the method 700. In some implementations, another device or a group of devices separate from or including the device (e.g., the training system 310, the informational device 330, the storage system 340, the computing device 360, and/or the user device 370) may perform or may be configured to perform the method 700. Additionally, or alternatively, one or more components of the device (e.g., processor 420, memory 430, input component 440, output component 450, and/or communication component 460) may perform or may be configured to perform the method 700. Thus, means for performing the method 700 may include the device and/or one or more components of the device. Additionally, or alternatively, a non-transitory computer-readable medium may store one or more instructions that, when executed by the device, cause the device to perform the method 700.

As shown in FIG. 7, the method 700 may include obtaining information indicating a configuration associated with a device type (block 710). As further shown in FIG. 7, the method 700 may include determining, using a machine learning model associated with a memory type, a compatibility between the memory type and the device type based on the configuration associated with the device type, where the machine learning model is trained to determine a compatibility of the memory type with a given configuration based on review data indicating reviews associated with historical interactions relating to the memory type (block 720).

The method 700 may include additional aspects, such as any single aspect or any combination of aspects described below and/or described in connection with one or more other methods or operations described elsewhere herein.

In a first aspect, the method 700 includes determining whether to recommend the memory type as being compatible with the device type based on the compatibility between the memory type and the device type that is determined using the machine learning model.

In a second aspect, alone or in combination with the first aspect, the machine learning model is further trained based on memory speed test data.

In a third aspect, alone or in combination with one or more of the first and second aspects, the machine learning model is further trained based on software execution data.

In a fourth aspect, alone or in combination with one or more of the first through third aspects, the method 700 includes parsing a document relating to the device type to identify the configuration associated with the device type.

In a fifth aspect, alone or in combination with one or more of the first through fourth aspects, the method 700 includes retrieving the information indicating the configuration associated with the device type from a data structure.

In a sixth aspect, alone or in combination with one or more of the first through fifth aspects, the device type is a type of computing device.

In a seventh aspect, alone or in combination with one or more of the first through sixth aspects, the configuration is at least one of a hardware configuration associated with the device type or a software configuration associated with the device type.

Although FIG. 7 shows example blocks of a method 700, in some implementations, the method 700 may include additional blocks, fewer blocks, different blocks, or differently arranged blocks than those depicted in FIG. 7. Additionally, or alternatively, two or more of the blocks of the method 700 may be performed in parallel. The method 700 is an example of one method that may be performed by one or more devices described herein. These one or more devices may perform or may be configured to perform one or more other methods based on operations described herein.

In some implementations, a method includes obtaining an input that identifies a device type; obtaining, based on the input, information indicating a configuration associated with the device type; determining, using a plurality of machine learning models respectively associated with a plurality of memory types, compatibilities between the plurality of memory types and the device type based on the configuration associated with the device type, wherein each of the plurality of machine learning models is trained to determine a compatibility of a respective memory type, of the plurality of memory types, with a given configuration; determining a recommendation of one or more memory types, of the plurality of memory types, for the device type based on the compatibilities between the plurality of memory types and the device type; and transmitting an indication of the recommendation of the one or more memory types.

In some implementations, a system includes one or more memories; and one or more processors, communicatively coupled to the one or more memories, configured to: obtain review data indicating a review associated with a historical interaction relating to a memory type; perform natural language processing of the review data to identify that the review relates to compatibility of the memory type; process the review data to identify one or more keywords indicative of a device type associated with the review; obtain information indicating at least one of a hardware configuration or a software configuration associated with the device type; and provide, for use as training data for a machine learning model to be trained to determine compatibility between a given device type and the memory type, information indicating the at least one of the hardware configuration or the software configuration associated with the device type and indicating whether the memory type and the device type are compatible based on the review.

In some implementations, a non-transitory computer-readable medium storing a set of instructions includes one or more instructions that, when executed by one or more processors of a device, cause the device to: obtain information indicating a configuration associated with a device type; and determine, using a machine learning model associated with a memory type, a compatibility between the memory type and the device type based on the configuration associated with the device type, wherein the machine learning model is trained to determine a compatibility of the memory type with a given configuration based on review data indicating reviews associated with historical interactions relating to the memory type.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
obtaining an input that identifies a device type;
obtaining, based on the input, information indicating a configuration associated with the device type;
determining, using a plurality of machine learning models respectively associated with a plurality of memory types, compatibilities between the plurality of memory types and the device type based on the configuration associated with the device type,
wherein each of the plurality of machine learning models is trained to determine a compatibility of a respective memory type, of the plurality of memory types, with a given configuration;
determining a recommendation of one or more memory types, of the plurality of memory types, for the device type based on the compatibilities between the plurality of memory types and the device type; and
transmitting an indication of the recommendation of the one or more memory types.

2. The method of claim 1, wherein obtaining the information indicating the configuration associated with the device type comprises:
parsing a document relating to the device type to identify the configuration associated with the device type.

3. The method of claim 1, wherein the configuration is at least one of a hardware configuration associated with the device type or a software configuration associated with the device type.

4. The method of claim 3, wherein the hardware configuration identifies at least one of one or more processors of the device type, a motherboard of the device type, one or more expansion cards of the device type, or one or more memory devices of the device type.

5. The method of claim 3, wherein the software configuration identifies at least one of a basic input/output system (BIOS) of the device type, an operating system of the device type, firmware of the device type, or application software of the device type.

6. The method of claim 1, wherein the plurality of machine learning models are trained based on review data indicating reviews associated with historical interactions relating to the plurality of memory types.

7. The method of claim 1, wherein the input indicates a model identifier that identifies the device type.

8. A system, comprising:
one or more memories; and
one or more processors, communicatively coupled to the one or more memories, configured to:
obtain review data indicating a review associated with a historical interaction relating to a memory type;
perform natural language processing of the review data to identify that the review relates to compatibility of the memory type;
process the review data to identify one or more keywords indicative of a device type associated with the review;
obtain information indicating at least one of a hardware configuration or a software configuration associated with the device type; and
provide, for use as training data for a machine learning model to be trained to determine compatibility between a given device type and the memory type, information indicating the at least one of the hardware configuration or the software configuration associated with the device type and indicating whether the memory type and the device type are compatible based on the review.

9. The system of claim 8, wherein the review data indicates a plurality of reviews associated with a plurality of historical interactions relating to the memory type, and
wherein the one or more processors are further configured to:
determine that the review is in agreement, as to compatibility, with a majority of the plurality of reviews,
wherein the one or more processors are configured to provide the information for use as the training data for the machine learning model based on determining that the review is in agreement with the majority of the plurality of reviews.

10. The system of claim 8, wherein the one or more processors are further configured to:
obtain information identifying an additional device type of a device that uses a memory device of the memory type and identifying results of a memory speed test for the memory device performed on the device;
determine, based on the results of the memory speed test, whether the memory type is compatible with the additional device type;
obtain information indicating a configuration associated with the additional device type; and
providing, for use as training data for the machine learning model, information indicating the configuration associated with the additional device type and indicating whether the memory type and the additional device type are compatible based on the results of the memory speed test.

11. The system of claim 8, further comprising:
obtain, based on execution of software in a memory device, of the memory type, upon installation of the memory device in a device, information identifying an additional device type of the device;
determine that the memory type is compatible with the additional device type based on obtaining the information identifying the additional device type;
obtain information indicating a configuration associated with the additional device type; and
provide, for use as training data for the machine learning model, information indicating the configuration associated with the additional device type and indicating that the memory type and the additional device type are compatible.

12. The system of claim 8, wherein the one or more processors, to perform natural language processing of the review data, are configured to:
perform semantic analysis of the review data to further identify a reason for incompatibility between the memory type and the device type; and
generate a report that indicates the reason for incompatibility between the memory type and the device type.

13. The system of claim 8, wherein the hardware configuration identifies at least one of one or more processors of the device type, a motherboard of the device type, one or more expansion cards of the device type, or one or more memory devices of the device type.

14. The system of claim 8, wherein the software configuration identifies at least one of a basic input/output system (BIOS) of the device type, an operating system of the device type, firmware of the device type, or application software of the device type.

15. A non-transitory computer-readable medium storing a set of instructions, the set of instructions comprising:
one or more instructions that, when executed by one or more processors of a device, cause the device to:
obtain information indicating a configuration associated with a device type; and
determine, using a machine learning model associated with a memory type, a compatibility between the memory type and the device type based on the configuration associated with the device type,
wherein the machine learning model is trained to determine a compatibility of the memory type with a given configuration based on review data indicating reviews associated with historical interactions relating to the memory type.

16. The non-transitory computer-readable medium of claim 15, wherein the one or more instructions, when executed by the one or more processors, further cause the device to:
determine whether to recommend the memory type as being compatible with the device type based on the compatibility between the memory type and the device type that is determined using the machine learning model.

17. The non-transitory computer-readable medium of claim 15, wherein the machine learning model is further trained based on at least one of memory speed test data or software execution data.

18. The non-transitory computer-readable medium of claim 15, wherein the one or more instructions, that cause the device to obtain the information indicating the configuration associated with the device type, cause the device to:
parse a document relating to the device type to identify the configuration associated with the device type.

19. The non-transitory computer-readable medium of claim 15, wherein the one or more instructions, that cause the device to obtain the information indicating the configuration associated with the device type, cause the device to:
retrieve the information indicating the configuration associated with the device type from a data structure.

20. The non-transitory computer-readable medium of claim 15, wherein the configuration is at least one of a hardware configuration associated with the device type or a software configuration associated with the device type.
